(19) United States
(12) Patent Application Publication
(10) Pub. No.: US 2007/0084111 A1
(43) Pub. Date: Apr. 19, 2007

(54) Method of obtaining crop production

(76) Inventor: Nicolaas Johannes Van der Merwe Maas, Sasolburg (ZA)

Correspondence Address: DARBY & DARBY P.C., P. O. BOX 5257, NEW YORK, NY, 10150-5257, US

(21) Appl. No.: 10/572,017

(22) PCT Filed: Sep. 6, 2004
(86) PCT No.: PCT/IB04/02881

§ 371 Date: Mar. 13, 2006

(30) Foreign Application Priority Data
Sep. 12, 2003 (ZA) 2003/2027

(51) Int. Cl. A01G 1/00

(52) U.S. Cl. 47/58.1 FV

(57) ABSTRACT

The invention concerns a method of predicting rainfall and crop production in regions of substantially varying rainfall in which run-up rainfall for a season is correlated with the growth season rainfall predicted from a pattern of growth season rainfall derived from historical records.

### FIELD OF THE INVENTION

This invention relates to a method of obtaining crop production by the controlled use of natural water supplies.

The invention also relates to novel methods of obtaining foreknowledge of crop growth season rainfall prior to planting time. This allows timely cultivation planning for better utilization of the rainfall to obtain more economical crop production.

### BACKGROUND TO THE INVENTION

In areas of substantially variable rainfall seasonal crops can be liable to serious periodic average harvest failures. These failed crops impact severely on farming activities and profitability. The basic reason for such failures is the incorrect crop planting procedures adopted against the rainfall pattern during the growth season. This is due mainly to lack of any reliable foreknowledge of the good or poor order of growth season rainfall and most importantly the component of rainfall coinciding with crop pollination and maturation.

Efforts to avoid the losses which occur have been limited to farmers relying on experience in order to try to program their procedures. Such efforts have shown no more than a seventy five percent reliability which is not generally satisfactory for viable long term farming operations.

### OBJECT OF THE INVENTION

It is an object of the invention to provide a method of obtaining more economically viable crop production than is presently obtained. This is to be achieved by the farmer more confidently pursuing crop cultivation planning than heretofore. It makes optimum use of growth season rainfall possible over many growth seasons of different rainfalls.

### SUMMARY OF THE INVENTION

In accordance with this invention there is provided a method of crop production in regions of substantially varying rainfall comprising the planting of the crop at a time determined by the correlation of the run-up rainfall for the season with a growth season rainfall predicted from a pattern of growth season rainfall derived from rainfall records for the region of planting.

Further features of the invention provide for the prediction to be obtained from a categorization derived from the pattern of the historical regional rainfall and the selection of cultivation program to be determined from the categorization.

In the specification “run-up rainfall” means the rainfall which occurs during a selected period prior to the usual planting period of a crop in a particular year. “growth season rainfall” is the rainfall from planting to harvesting of a crop “late rainfall” is rainfall during crop pollination and maturation.

The invention also provides for the categorization to be obtained by a comparison of crop yields against similar growth season rainfall patterns over an extended period of years. (In South Africa such records are available over a period of seventy-five years). The comparison may further be made by choosing historical years having similar run-up and early growth season rainfall to the year of planting and correlating the growth season rainfall against crop yield to select a cultivation program for the specific planting season crop.

The invention further provides patterns and categories of information derived from historical rainfall and crop productions for use in the invention defined above.

Generally therefore in this way crop production can be effected inter alia by planting at a time which is indicated to give adequate growth period rainfall. Further the cultivation program can be determined to give best results for predicted rainfall and thus avoid loss. The cultivation program refers to determination not only of planting time but includes all other aspects such as choice of variety of crop, fertilizer application and density of planting for example.

### DESCRIPTION OF THE INVENTION

By way of example only and without limitation to the scope of this invention the method of crop planting was effected on the basis of the following description of preliminary determination of expected growth period rainfall specifically for the Sandveld region of the Western Cape Province in South Africa.

To obtain a pattern and categorization for predictability of rainfall to achieve crop success it is necessary that access be had to historical rainfalls over consecutive periods to enable categories of norms of high consistency to be extracted over as long a period as possible. Six such categories have been identified in 75 years extending from 1925 for the Sandveld region. Four cover less than 9 years each, one 4 years and the remaining one 32 years.

To use a category as a platform for working towards complete predictability one needs to derive one category that is dominant as either a “good” G or “poor” P crop yield year. Where a separation of years with G and P ratings is such that a category is not very dominant in any of them, subcategorisation is obtained by using finer variations on the usual run-up rainfall norms or by using norms applying to designated periods in the overall run-up rainfall period. This has been found to be a highly successful technique to get separation of rainfall patterns into G or P categories in summer rainfall regions.

The rainfalls of all past years were first individually rated as G- or P- based on their “late” rainfalls for successful crop production on experienced norms of what rainfall must be to pass as G or otherwise be P.

This selection of rainfalls into patterns already gives, for purposes of rainfall projection, a good separation of good and poor year indicators. Two of the smaller Sandveld patterns thrown up by this process contain about half of the 25 P years experienced since 1925 in their combined total of 15 years with a consistency of some 90% therein.

Three other, also smaller ones, are one 100% and two 85% G and a fairly big one (32 years) 70% G. All this makes the year specific rainfall prediction much simpler.

The invention also provides that some auxiliary fully consistent categories can be indirectly deduced from rainfall patterns, e.g. unbroken sequences of two years composed of any couple or combination of good G-rainfall patterns (85% to 100% G) always being followed up by a P-year. The correlation is referred to in this specification as a “rule” and could by itself have irrefutably indicated or confirmed the P-status of 12 of the 25 P-years since 1925. Another similarly derived category indication, enabled a further 4 P-years to be pinpointed.

The absolutely consistent kind of pattern-based correlations and their connection with P-year outcomes, augmented by a few natural, mostly rainfall structure, correlations could in fact, it was found, have been used to project all the Sandveld P-years since 1925 year specifically. Therefore by difference also all G-years could be so predicted allowing one to submit that Sandveld rainfalls were unquestionably practically all predictable on the G and P of their late rainfall and will also be found to be so in future.

The invention of course provides through the historical typical average monthly rainfalls of each pattern, useful information on full growth season period rainfall in general. This also is of considerable value for the utility of the invention itself.

For example a “wet” April pattern is a year typically good in general rainfall except that 30% of the time its late rainfall is poor. Knowing however beforehand when it would be G, which it is 70% of the time, would support confident planning for top harvests in such years. Knowing which 30% of years would be poor in late rainfall could help to retrieve some of them as good harvest years by merely ensuring that planting was completed early in April.

Generally the requirements for a good crop may be set out as follows:

Region: Sandveld—Marginal dry land cultivation

Typical Rainfall: Winter

Crop: Wheat—growth period 3½ to 4 months

Crop Growth Season: April-October

Planting time: April (ideal)-Mid June (Depending on adequate rainfall for seed bed preparation (ploughing)

Critical Rainfall for Good Crop Yields: i.e. “late” Rainfall—August>37 mm. and/or August/September>45 mm or on very late plantings August/October>58 mm

Poor Critical Rainfall that can result in Poor Crop Yields: August/September<45 mm. or on late plantings August/October<58 mm.

Note: All good and poor year ratings hereunder relate to the foregoing Good (G) and Poor (P) norms on basically August/September (late) rainfalls in the Sandveld. Past Rainfall Records—75 years, monthly intervals

Some categorization results extracted from the historical records are set out below.

(Predominant G or P indication on crop prospects 75%-90%)

| | |
|---|---|
| (1) April >9 mm. but <22.5 mm. | Generally unfavourable for planting. |
| May >30 mm. (Planting can | Note: needs sub-categorisation - |
| commence) | itself not used as a pattern. |
| (2) (γ) A subcategorisation of (1) | Always good in late rainfall and |
| April >9 mm. and May <30 mm. and | yields |
| June >30 mm. | |
| (3) (α) A subcatergorisation of (1) | Predominantly poor (85%). |
| May >30 mm. and June <30 mm | Exceptions all predictable |
| (4) (Σ) A subcatecorisation of (1) | Predominantly poor or unplantable. |
| May <25 mm. June <30 mm. | |
| (5) (θ)Selected category of April >22.5 mm. | Predominantly good in late rainfall |
| | and yields (±70%). Exceptions all |
| | predictable |
| (6) Apr. <9 mm. | Predominantly good; but needs |
| | subcategorisation (- itself not used |
| | as a pattern) |
| (7) (φ) Subcategory of 6 | Predominantly good |
| April <9 mm.; May >30 mm. | |
| (8) (φ₁)Subcategory of 6 | Predominantly good |
| April <9 mm.; May <25 mm.; | |
| June >25 mm. | |
| (9) A loose correlation on 20% of years | Predominantly good yields (±66%). |
| February >15 mm. (Preplanting time - | Exceptions all predictable |
| Direct correlation but very inconsistent | |
| at 66%) | |
| (10) A loose correlation | Always poor - except if April <9 mm. |
| March >30 mm. (Preplanting time) | (Has preplanting time availability) |
| Note: One of the few consistent direct | |
| correlations - occurrence only 5%. | |
| (11) A loose correlation | Poor but could be good if planting is |
| April >65 mm. (One of the few consistent direct | completed before end April. (Has |
| correlations - occurrences 4%) | preplanting time availability) |
| (12) A loose correlation | Follow-up year predominantly poor. |
| Two consecutive yearly rainfalls >550 mm. | |

The following is one of the typical correlations on rainfall structures that leads to finally defined preplanting projections of winter rainfall in Sandveld.

There is never in poor year occurrences more than 3 single poor late rainfall years that is not subsequently followed by double poor late rainfall years. If 3 single poor crop years have been experienced over an unbroken period, the next poor crop year can be assumed as being the first of two successive poor crop years i.e. the first leg of a double poor year cycle.

There is never more than 2 successive poor late rainfall years in a row. During the second year of such a cycle (occurrence about every 10 years) it is certain that it would be followed by a good late rainfall year.

A cycle of 4 good late rainfall years in a row will always be followed by a P-year.

The following is typical of a consistent rainfall pattern:

A poor year will always follow year combinations of the 3 good late rainfall grouping of years within the developed categories. As explained above this pertains to an absolutely dominant correlation, consistent and fairly frequently occurring, and overriding any good year indication for e.g. a good rainfall pattern or a natural correlation. This “rule” is identifiable solely because a method of splitting up records of rainfall into patterns and categories is used. It is supplemented though in coverage in this respect by the consistent drought pattern cycle P-year indications and a few other such consistent and dominant natural correlations to predict poor years. This ensures that nearly all poor (P) late rainfall years in the Sandveld can be predicted a year beforehand.

With all the poor year exceptions on the good (G) year patterns and categories and vice versa thus predictable, the overall net result is that virtually total year specific predictability of G and P of late rainfalls for virtually all years in the patterns categories could be attained. Very important to note here is that it means the farmer can now also use knowledge of general typical rainfall of the identified category concerned to pursue least risk optimization planning on crop cultivation.

One need not stop with such findings with the effort of confirming or double confirming principal indications because there are still some further indications which can be determined.

One is to be found in a two multiple rule derivable from the fact that good (G) years invariably come in cycles of two or four years.

An in-depth analysis shows that by this latter rule alone virtually all good and poor years in a historical sample of Sandveld years could have been predicted by bringing less than half of the dominant poor year indications into play. Without use of the new methodology set out above, it could not provide more than say 75% predictability.

Year specific prediction of G/P late rainfalls of Sandveld's years of April>22.5 mm.

This example of 32 Sandveld years since 1925 with wet April pattern and category selection was picked to illustrate here how this kind of prediction as defined was achieved in practice for this winter rainfall wheat producing region. For this purpose Table A of wet April pattern rain records in the region's last covering report on its rainfall predictability (October 2001) is given hereunder with the G and P ratings of their rainfalls in the second last vertical column. G for above 45-48 mm. range August/September rainfall and P for below that range. Where there is no prior P year indicator, as for example β, χ₁ in the following table, a cut-off point for G of 45 mm is to be accepted.

TABLE A

| | | | | | | | | | | | | | Aug/ | G | P- |
|---|---|---|---|---|---|---|---|---|---|---|---|---|---|---|---|
| Year | Jan | Feb | Mar | Apr | May | Jun | Jul | Aug | Sep | Oct | Nov/Dec | Tot | Sept | or P | Indication |
| 1929 | 0 | 3.8 | 2.8 | 22.6 | 37.3 | 49.8 | 24.6 | 24.4 | 23.1 | 4.3 | 18 | 210.8 | 47.5 | G | |
| 1931 | 0 | 3.8 | 0.5 | 63.2 | 19.6 | 10.9 | 25.9 | 56.1 | 15.5 | 15.5 | 10 | 221.2 | 71.6 | G | |
| 1935 | 4.1 | 0 | 5.3 | 38.1 | 40.1 | 19.1 | 26.7 | 64 | 35.6 | 8.1 | 11 | 252.0 | 99.6 | G | |
| 1938 | 6.6 | 3 | 0 | 34.8 | 30.2 | 13.2 | 13.2 | 8.1 | 23.9 | 10.4 | 11 | 154.1 | 32.0 | P | β |
| 1940 | 0.3 | 3.5 | 10 | 23.1 | 17.6 | 41.1 | 12.2 | 18.5 | 27.1 | 12.7 | 22 | 188.0 | 45.6 | P | α₁ |
| 1941 | 19.8 | 0.5 | 0.8 | 54.9 | 81 | 70.6 | 46 | 55.9 | 43.2 | 24.9 | 3 | 400.5 | 99.1 | G | |
| 1942 | 1 | 0 | 0 | 31 | 23.4 | 72.6 | 12.7 | 58.7 | 7.1 | 6.1 | 47 | 259.8 | 65.8 | G | |
| 1945 | 0.3 | 2.5 | 2 | 24.9 | 43.7 | 71.4 | 45.7 | 26.2 | 2.5 | 17.3 | 5 | 241.9 | 28.7 | P | β |
| 1946 | 0.8 | 1.3 | 10.4 | 31 | 20.1 | 19.8 | 14.2 | 18.5 | 89.9 | 10.7 | 3 | 219.6 | 108.4 | G | |
| 1949 | 0.3 | 0 | 3.6 | 26.9 | 36.3 | 15.6 | 30.2 | 42.4 | 36.8 | 27.4 | 17 | 236.0 | 79.2 | G | |
| 1950 | 0 | 1.3 | 4.8 | 34 | 7.6 | 16 | 72.8 | 2 | 43.7 | 15.7 | 19 | 216.4 | 45.7 | P | α₁ |
| 1953 | 0 | 2 | 3 | 93.7 | 46.7 | 12.2 | 77.7 | 28.7 | 2.5 | 3.5 | 17 | 286.6 | 31.2 | P | B |
| 1954 | 5.1 | 1.5 | 8.1 | 37.6 | 40.7 | 52.1 | 83.3 | 56.4 | 7.1 | 20.1 | 13 | 324.9 | 63.5 | G | |
| 1955 | 0 | 34.3 | 1.8 | 25.1 | 1.3 | 78.7 | 53.8 | 72.8 | 7.9 | 22.4 | 21 | 318.9 | 80.7 | G | |
| 1959 | 1.8 | 6.1 | 6.6 | 23.9 | 106.7 | 10.2 | 29.2 | 48.8 | 16 | 17.3 | 8 | 274.5 | 64.8 | G | |
| 1961 | 3.6 | 2.3 | 2 | 48.8 | 33.3 | 56.9 | 39.9 | 39.6 | 29.7 | 6.1 | 6 | 267.8 | 69.3 | G | |
| 1962 | 2 | 9.9 | 1 | 23.1 | 17.5 | 24 | 44.7 | 95.8 | 14.5 | 25.1 | 23 | 281.0 | 110.3 | G | |
| 1965 | 11 | 15 | 24 | 29 | 12.7 | 18.8 | 19.3 | 32.3 | 14.7 | 8.4 | 21 | 206.8 | 47 | P | B |
| 1967 | 1 | 21 | 2 | 56.4 | 37.1 | 88.1 | 18.8 | 27.2 | 24.9 | 13 | 19 | 308.9 | 52.1 | G | |
| 1968 | 0 | 0.3 | 22 | 22.9 | 51.3 | 44.2 | 24.9 | 37.3 | 2.5 | 30.5 | 6 | 242.6 | 39.8 | G | |
| 1976 | 6 | 2.7 | 3 | 91.2 | 12.3 | 94.5 | 71.6 | 22 | 11 | 7 | 82 | 403.3 | 33.0 | P | χ₁ |
| 1977 | 8.7 | 18 | 5.5 | 33 | 98.5 | 71.2 | 59.4 | 50.7 | 22.6 | 7.5 | 30 | 404.8 | 73.3 | G | |
| 1980 | 2 | 4.8 | 0 | 28.1 | 43.8 | 55.5 | 10 | 51 | 4.2 | 6.5 | 43 | 249.3 | 52.2 | G | |
| 1982 | 20 | 2 | 24 | 33.1 | 19 | 48.1 | 38.4 | 20.2 | 4 | 22.2 | 24 | 254.9 | 24.2 | P | δ₄₊ |
| 1985 | 13 | 5.5 | 45 | 27.7 | 47.5 | 31.1 | 51.4 | 26.7 | 21.2 | 4.7 | 46 | 318.7 | 47.9 | P | B |
| 1987 | 0 | 1.7 | 1.6 | 35 | 23.6 | 42.5 | 67.7 | 51.1 | 51.5 | 5.5 | 22 | 302.2 | 102.6 | G | |
| 1988 | 0 | 1.2 | 11 | 51.2 | 33.4 | 41 | 23.8 | 31.9 | 28.5 | 1 | 13 | 235.5 | 60.4 | G | |
| 1989 | 2.5 | 7.5 | 20 | 33.2 | 18.3 | 43.5 | 53.4 | 76 | 34.7 | 22.6 | 15 | 326.9 | 110.7 | G | |
| 1990 | 1.5 | 9.7 | 0 | 55.1 | 60 | 55.1 | 63.9 | 18.3 | 6.5 | 3.2 | 8 | 281.6 | 24.8 | P | δ₄₊ |
| 1993 | 0 | 12 | 6 | 75.1 | 115.3 | 23 | 63.9 | 28.3 | 9.5 | 0 | 19 | 352.1 | 37.8 | P | B |
| 1994 | 0 | 0 | 0 | 23.8 | 17 | 112 | 34.8 | 3.2 | 25.4 | 27 | 4 | 247.1 | 28.6 | P | X |
| 1999 | 0.3 | 6 | 0 | 26 | 19.2 | 31.3 | 26.9 | 50 | 62.3 | 1.3 | 15 | 238 | 112.3 | G | |
| Ave. | 3 | 6 | 7 | 39 | 38 | 45 | 40 | 39 | 23 | 13 | 19 | 273 | 62 | | |
| 75- | 3 | 5.5 | 11 | 23 | 35 | 44 | 37 | 37 | 21 | 14 | 19 | 249 | 58 | | |
| yr | | | | | | | | | | | | | | | |
| Ave | | | | | | | | | | | | | | | |

Note that this table as well as those for other rainfall patterns was obtained by the technique of categorization of rainfalls. This table illustrates incidentally the point that even a good (G) and large rainfall grouping generated by categorization could have less than 70% consistency in its G-indication.

The last vertical column of the table is added to reflect where “late” P rainfall indicators were available (of course now so identifiable in hindsight from rain records and for this reason also identifiable in run-up rainfalls of future years) to going out a year beforehand whether a year's late rainfall would be G or P. And this was all that was needed to declare all P years in the table, and hence by difference, all its G-years, as year specifically predictable.

It is believed that this table reflects very much the outcome of a historical first effort to prove full year specific predictability of rainfall, confirming this work on using basically the cyclical nature of rainfall to determine crop planting and why the principle of projecting forward rainfall by deductions made from past rainfalls is valid and validates the whole underlying hypothesis proceeded from in the relevant research that this is so.

The use of the method set out above show that G and P predictions for G and P years in the Sandveld over a period of three years prior to the date of writing would have been accurate.

From the above it will be appreciated that other correlations from the historical records of rainfall patterns and crop production can be developed in other regions for use in the production of crops according to the invention which are also location and time specific and will result in satisfactory or simply more profitable crop production under previously adverse conditions.

1. A method of crop production in regions of substantially varying rainfall comprising the planting of the crop at a time determined by the correlation of the ran-up rainfall for the season with a growth season rainfall predicted from a pattern of growth season rainfall derived from rainfall records for the region of planting.

2. A method of crop production as claimed in claim 1 wherein the rainfall prediction is obtained from a categorization derived from the pattern of the regional rainfall.

3. A method of crop production as claimed in claim 2 the prediction is used to determine a cultivation program for the crop.

4. A method of crop production as claimed in claim 2 wherein the categorization is obtained by a comparison of the good or poor assessed crop yield potential against those of similar growth season rainfall patterns over an extended period of years.

5. A method of crop production as claimed in claim 4 wherein the comparison further includes the choice of historical years having similar run-up rainfall.

6. A method of crop production as claimed in claim 5 wherein the comparison further includes the choice of historical years having similar early growth season rainfall.

7. A compilation of patterns and categories of information derived from historical seasonal rainfall and crop production records for use in the method of claim 2.

8. A method of predicting growth season rainfall for a season in a region of substantially varying rainfall comprising measuring the run-up rainfall for the season and correlating the measured rainfall to a growth season rainfall categorized from growth season rainfall pattern records for the region.

9. A method of crop production as claimed in claim 3 wherein the categorization is obtained by a comparison of the good or poor assessed crop yield potential against those of similar growth season rainfall patterns over an extended period of years.
